(19) United States
(12) Patent Application Publication
(10) Pub. No.: US 2024/0117111 A1
(43) Pub. Date: Apr. 11, 2024

(54) PROCESS FOR BRANCHED POLYESTERS FOR EXTRUSION COATING AND RELATED PRODUCTS

(71) Applicant: NOVAMONT S.P.A., Novara (IT)

(72) Inventors: Catia BASTIOLI, Novara (IT); Tiziana MILIZIA, Novara (IT); Angelos RALLIS, Novara (IT); Roberto VALLERO, Borgo D'Ale (VC) (IT)

(21) Appl. No.: 18/263,737

(22) PCT Filed: Feb. 1, 2022
(86) PCT No.: PCT/EP2022/052331

§ 371 Date: Aug. 1, 2023

(30) Foreign Application Priority Data
Feb. 2, 2021 (IT) 102021000002135

(51) Int. Cl. C08G 63/20; B32B 27/36; C08G 63/183; C08G 63/85; C08J 5/18; C08J 7/04

(52) U.S. Cl. CPC C08G 63/20; B32B 27/36; C08G 63/183; C08G 63/85; C08J 5/18; C08J 7/0427; C08G 2150/00; C08G 2170/20; C08G 2230/00; C08J 2367/03

(57) ABSTRACT

The present invention relates to a biodegradable branched polyester particularly suitable for use in extrusion coating and lamination, and the process for obtaining it.

The project leading to this application has received funding from the Bio Based Industries Joint Undertaking (JU) under grant agreement No 837866. The JU receives support from the European Union's Horizon 2020 research and innovation programme and the Bio Based Industries Consortium.

The present invention relates to a process for the preparation of a biodegradable branched polyester particularly suitable for use in extrusion coating and lamination, and to the product thereof.

Extrusion coating and lamination are processes that allow several substrates to be combined to obtain a single compound structure. Extrusion coating allows a layer of melted polymer to be applied to a substrate, while with extrusion lamination the melted polymer is deposited between two substrates as a binder.

Such processes are for example widely used in food contact packaging. Conventional materials are based on low-density polyethylene (LDPE) and provide adequate performance through their use as a coating on various substrates (e.g. paper, cardboard). However, the use of such packaging has limitations in terms of environmental impact.

Of particular interest is the development of new materials that not only perform as well as conventional materials in industrial coating processes, but are also biodegradable.

Polyesters with long chain branching exhibit rheological properties that make them particularly efficient in this type of industrial coating process.

In the known art, biodegradable branched polyesters are described as for example in patent EP3231830A1, but are used for extrusion foaming.

WO2009118377A1 describes a biodegradable polyester with long chain branches, characterised by good rheological properties for extrusion coating. Such a polyester is obtained by a process in which the precursor polyester is initially formed, and then a reactive extrusion is carried out to obtain the long chain branched polyester by the addition of a compound chosen from peroxides, epoxides and carbodiimides.

There is therefore a need to find a process with fewer stages than WO2009118377A1 and which enables polyesters with improved rheological properties to be obtained for extrusion coating and extrusion lamination applications.

In addition, there is a particular need for polyesters with improved rheological properties for extrusion coating and extrusion lamination.

A first object of the present invention is therefore a process for obtaining a biodegradable branched polyester for extrusion coating. The process according to the present invention comprises (i) an esterification/transesterification step in the presence of the diol and dicarboxylic components, and at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group, and an esterification/transesterification catalyst; and (ii) a polycondensation step in the presence of a polycondensation catalyst.

In esterification/transesterification step (i), the dicarboxylic acids, their esters or their salts, the aliphatic diols, the polyfunctional compound and any other co-monomers constituting the polyester may be fed separately, thus mixing in the reactor. Alternatively, in esterification/transesterification step (i), the dicarboxylic acids, their esters or salts, the aliphatic diols, the polyfunctional compound and any other co-monomers constituting the polyester may be pre-mixed, preferably at a temperature below 70° C., before being sent to the reactor. It is also possible to pre-mix some of the components and subsequently change their composition, for example during the esterification/transesterification reaction.

In the case of polyesters in which the dicarboxylic component comprises repeating units derived from several dicarboxylic acids, whether aliphatic or aromatic, it is also possible to pre-mix some of these with aliphatic diols, preferably at a temperature below 70° C., by adding the remaining portion of the dicarboxylic acids, diols and any other co-monomers to the esterification/transesterification reactor for step (i).

The esterification/transesterification step (i) is preferably fed with a molar ratio between the aliphatic diols and the dicarboxylic acids, their esters and their salts which is preferably between 1 and 2.5, preferably between 1.05 and 1.9.

Esterification/transesterification step (i) in the process according to the present invention is advantageously performed at a temperature of 200-250° C., preferably 220-240° C., and a pressure of 0.7-1.5 bar, in the presence of an esterification/transesterification catalyst.

The catalyst in esterification/transesterification step (i), which can advantageously also be used as a component of the catalyst for polycondensation step (ii), may in turn be fed directly to the esterification/transesterification reactor or may also first be dissolved in an aliquot of one or more of the dicarboxylic acids, their esters or salts, and/or aliphatic diols, so as to facilitate dispersion in the reaction mixture and make it more uniform.

The catalyst for the esterification/transesterification step(s) is chosen from among organometallic tin compounds, for example stannoic acid derivatives, titanium compounds, for example titanates such as tetrabutyl ortho-titanate or tetra(isopropyl) ortho-titanate, or diisopropyl triethanolamine titanate, zirconium compounds, e.g. zirconates such as tetrabutyl ortho zirconate or tetra(isopropyl) ortho zirconate, Antimony compounds, Aluminium compounds, e.g. Al-triisopropyl, Magnesium compounds, Zinc compounds and mixtures thereof.

In a preferred embodiment, the titanium-based catalyst for esterification/transesterification step (i) is a titanate advantageously chosen from compounds having the general formula Ti(OR)4 in which R is a ligand group comprising one or more Carbon, Oxygen, Phosphorus and/or Hydrogen atoms.

Several R ligand groups may be present on the same titanium atom, but are preferably identical in order to facilitate preparation of the titanate.

In addition, 2 or more R ligands may be derived from a single compound and may be chemically bound together in addition to being bound to the titanium (so-called multidentate ligands such as triethanolamine, citric acid, glycolic acid, malic acid, succinic acid, ethane diamine).

R is advantageously selected from H, triethanolamine, citric acid, glycolic acid, malic acid, succinic acid, 3-oxobutanoic acid, ethane diamine and linear or branched C1-C12 alkyl residues such as ethyl, propyl, n-butyl, pentyl, isopropyl, isobutyl, isopentyl, hexyl, ethylhexyl. In a preferred embodiment, R is selected from C1-C12 alkyl residues, preferably C1-C8, more preferably n-butyl.

The preparation of the titanates is known from the literature. These are typically prepared by reacting titanium tetrachloride and the precursor alcohol of formula ROH in the presence of a base such as ammonia, or by the transesterification of other titanates.

Commercial examples of titanates that may be used in the process according to the present invention include Tyzor® TPT (tetra isopropyl titanate), Tyzor® TnBT (tetra n-butyl titanate) and Tyzor® TE (diisopropyl triethanolamino titanate).

If the Zirconium-based esterification/transesterification catalyst is used in conjunction with the Titanium-based catalyst, this will be a zirconate advantageously chosen from compounds having the general formula Zr(OR)₄ in which R is a ligand group comprising one or more atoms of Carbon, Oxygen, Phosphorus and/or Hydrogen.

As in the case of titanates, several different, but preferably identical, R ligand groups may be present on the same zirconium atom to facilitate preparation of the zirconate.

In addition, 2 or more R ligands may be derived from a single compound or may be chemically bound together in addition to being bound to the Zirconium (so-called multidentate ligands such as triethanolamine, citric acid, glycolic acid, malic acid, succinic acid, ethane diamine). R is advantageously chosen from H, triethanolamine, citric acid, glycolic acid, malic acid, succinic acid, 3-oxobutanoic acid, ethane diamine and linear or branched C1-C12 alkyl residues such as ethyl, propyl, n-butyl, pentyl, isopropyl, isobutyl, isopentyl, hexyl or ethylhexyl. In a preferred embodiment R is chosen from C1-C12, preferably CT-C8, alkyl residues, more preferably n-butyl.

The preparation of zirconates is known in the literature, and is similar to that described above for titanates.

Commercial examples of zirconates which may be used in the process according to the present invention include Tyzor® NBZ (tetra n-butyl zirconate), Tyzor NPZ (tetra n-propyl zirconate), IG-NBZ (tetra n-butyl zirconate), Tytan TNBZ (tetra n-butyl zirconate), Tytan TNPZ (tetra n-propyl zirconate).

With respect to the organometallic catalysts of the above-mentioned type for esterification/transesterification step (i), during the esterification/transesterification step in the process according to the present invention they are present in concentrations preferably between 6 and 120 ppm of metal with respect to the amount of polyester that can theoretically be obtained by converting all the dicarboxylic acid fed to the reactor.

In a preferred embodiment, the catalyst for esterification/transesterification step (i) is a titanate, more preferably diisopropyl triethanolamine titanate, preferably used in a concentration of 12-120 ppm of metal relative to the amount of polyester that can theoretically be obtained by converting all the dicarboxylic acid fed to the reactor.

Preferably, the reaction time for the esterification/transesterification step(s) in the process according to the present invention is between 4 and 8 hours.

At the end of esterification/transesterification step (i), an oligomer product having Mn less than 5000, an inherent viscosity of 0.05-0.15 dl/g, and an acidity of less than 150 meq/kg, preferably less than 100 meq/kg, is obtained.

The Mn value is measured using chloroform as eluent at 0.5 ml/min on suitable columns (e.g., PL-gel columns (300×7.5 mm, 5 μm—mixed bed C and E) and a PLgel Guard precolumn (50×7.5 mm 5 μm) connected in series) and a refractive index detector. The determination is made using a universal calibration made with PS standard.

The inherent viscosity is measured in chloroform at 25° C. with a concentration of 2 g/l according to ISO 1628-2015.

Acidity is measured by potentiometric titration. An exactly weighed quantity of sample is dissolved in 60 ml chloroform, 25 ml of 2-propanol is added to the clear solution and, immediately before titration, 1 ml water is added. The titration is carried out with a 0.025N KOH solution in ethanol using an electrode for non-aqueous solutions (e.g., Solvotrode Metrohm). The solvent mixture is titrated similarly for the blank determination.

The acidity value, expressed in meq/kg of polymer, is derived from the following equation

CEG=(Veq−Vo)x titre/P sample

### Where:

Veq=equivalent volume of the sample obtained by titration expressed in ml
V0=equivalent volume of the blank obtained by titration expressed in ml
Titre=normality of titrant solution
P sample=sample weight in kg.

In a preferred embodiment of the process according to the present invention, the catalyst is fed to polycondensation step (ii) together with the oligomer product obtained at the end of esterification/transesterification step (i).

Polycondensation step (ii) in the process according to the present invention is advantageously performed at a temperature of 200-270° C., preferably 230-260° C., and a pressure of less than 10 mbar, preferably less than 3 mbar, and greater than 0.5 mbar, in the presence of a poly condensation catalyst.

Polycondensation step (ii) in the process according to the present invention is performed in the presence of a catalyst based on a metal preferably selected from titanium, zirconium or mixtures thereof, with a total amount of metal of 80-500 ppm, compared to the amount of polyester that could theoretically be obtained by converting all the dicarboxylic acid fed to the reactor. If present, the total amount of Zirconium should be such that the Ti/(Ti+Zr) ratio is maintained within the range 0.01-0.70.

In a preferred embodiment, the titanium-based catalyst for polycondensation step (ii) is a titanate advantageously chosen from compounds having the general formula Ti(OR)₄ in which R is a ligand group comprising one or more Carbon, Oxygen, Phosphorus and/or Hydrogen atoms.

Several ligand groups R may be present on the same titanium atom, but are preferably identical in order to facilitate preparation of the titanate.

In addition, 2 or more ligands R may be derived from a single compound and may be chemically bonded together in addition to being bonded to the titanium (so-called multidentate ligands such as triethanolamine, citric acid, glycolic acid, malic acid, succinic acid, ethane diamine).

R is advantageously selected from H, triethanolamine, citric acid, glycolic acid, malic acid, succinic acid, 3-oxobutanoic acid, ethane diamine and linear or branched C1-C12 alkyl residues such as ethyl, propyl, n-butyl, pentyl, isopropyl, isobutyl, isopentyl, hexyl, ethylhexyl. In a preferred embodiment, R is selected from C1-C12, preferably C1-C8, alkyl residues, more preferably n-butyl.

The preparation of titanates is known from the literature. These are typically prepared by reacting titanium tetrachloride and the precursor alcohol of formula ROH in the presence of a base such as ammonia, or by the transesterification of other titanates.

Commercial examples of titanates that can be used in the process according to the present invention include Tyzor® TPT (tetra isopropyl titanate), Tyzor® TnBT (tetra n-butyl titanate) and Tyzor® TE (diisopropyl triethanolamine titanate).

If the Zirconium-based polycondensation catalyst is used in conjunction with the Titanium-based catalyst, this will be a zirconate advantageously chosen from compounds having the general formula Zr(OR)₄ in which R is a ligand group comprising one or more atoms of Carbon, Oxygen, Phosphorus and/or Hydrogen.

As in the case of titanates, several different, but preferably identical, ligand groups R may be present on the same zirconium atom to facilitate preparation of the zirconate.

In addition, 2 or more ligands R may be derived from a single compound or may be chemically bonded together in addition to being bonded to the Zirconium (so-called multidentate ligands such as triethanolamine, citric acid, glycolic acid, malic acid, succinic acid, ethane diamine). R is advantageously chosen from H, triethanolamine, citric acid, glycolic acid, malic acid, succinic acid, 3-oxobutanoic acid, ethane diamine and linear or branched C1-C12 alkyl residues such as ethyl, propyl, n-butyl, pentyl, isopropyl, isobutyl, isopentyl, hexyl or ethylhexyl. In a preferred embodiment, R is chosen from C1-C12, preferably CT-C8, alkyl residues, more preferably n-butyl.

The preparation of zirconates is known in the literature, and is similar to that described above for titanates.

Commercial examples of zirconates that may be used in the process according to the present invention include Tyzor® NBZ (tetra n-butyl zirconate), Tyzor NPZ (tetra n-propyl zirconate), IG-NBZ (tetra n-butyl zirconate), Tytan TNBZ (tetra n-butyl zirconate), Tytan TNPZ (tetra n-propyl zirconate).

When a catalyst containing Titanium and/or Zirconium compounds is used in esterification/transesterification step (i), in a preferred embodiment of the process according to the present invention this catalyst is not separated from the product from step (i) and is fed together with it to polycondensation step (ii) and is advantageously used as a poly condensation catalyst or as a component thereof, with possible adjustment of the molar ratio between Titanium and Zirconium by the addition of suitable amounts of Titanium and Zirconium compounds to said poly condensation step (ii).

It is possible that the catalyst for polycondensation step (ii) may be the same as that for esterification/transesterification step (i).

More preferably, the catalyst used in esterification/transesterification step (i) and poly condensation step (ii) is a Titanium compound.

Polycondensation step (ii) is advantageously carried out by feeding the product of step (i) to the polycondensation reactor and reacting it in the presence of the catalyst at a temperature of 220-260° C. and a pressure of between 0.5 mbar and 350 mbar.

Preferably, the reaction time for the polycondensation step in the process according to the present invention is between 4 and 8 hours.

Polycondensation step (ii) in the process according to the present invention may be carried out in the presence of a phosphorus-containing compound belonging to the phosphate family or organic phosphites.

At the end of polycondensation step (ii), a polyester according to the present invention is obtained having Mn between 25000 and 80000, preferably between 40000 and 70000, an inherent viscosity between 0.4 and 1.2 dl/g, preferably between 0.7 and 1.1 dl/g, and an acidity of less than 100 meq/kg, preferably less than 60 meq/kg.

This process does not require an additional reactive extrusion stage to obtain the branching.

In a preferred embodiment, the process according to the present invention consists of (i) an esterification/transesterification step in the presence of the diol and dicarboxylic components, and at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group, and an esterification/transesterification catalyst; and (ii) a polycondensation step in the presence of a polycondensation catalyst.

In another preferred embodiment, the process according to the present invention consists of (i) an esterification step in the presence of the diol and dicarboxylic components, and at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group, and an esterification catalyst; and (ii) a polycondensation step in the presence of a poly condensation catalyst.

Biodegradable branched polyesters obtained by the process according to the present invention constitute a second object of the present invention, such polyesters being characterised by branching obtained by means of at least one polyfunctional compound containing at least four acid (COOH) or at least four hydroxyl (OH) functional groups, and by a viscoelastic ratio (RVE) of less than 40000. The polyester object of the present invention is characterised by a lower RVE compared to polyesters subjected to the reactive extrusion step, and is advantageously processable at lower temperatures, favouring energy savings and limiting the risks of thermal degradation of the material.

Surprisingly, the polyester obtained by the process according to the present invention exhibits improved rheological properties in terms of melt thermal stability, high Breaking Stretching Ratio and polydispersity index.

From a rheological point of view, a polymer with long chain branches is characterised by high melt strength values and low shear viscosity values, the elongation properties being much more amplified by the long branches than by the molecular weight. In order to assess the quality of the melt and its possible processing behaviour in industrial coating processes it is therefore necessary to consider both properties by means of the viscoelastic ratio, RVE. This is calculated from the quotient of shear viscosity and melt strength. Shear viscosity is determined at 180° C. and flow gradient γ=103.7 s⁻¹ with a 1 mm diameter capillary and L/D=30 according to ASTM D3835-90 “Standard Test Method for Determining Properties of Polymer Materials by means of a Capillary Rheometer”, while melt strength is measured according to ISO 16790:2005 at 180° C. and γ=103.7 s⁻¹ using a capillary of diameter 1 mm and L/D=30 at a constant acceleration of 6 mm/sec² and a stretching length of 110 mm.

Branching of the polyester according to the present invention is obtained using monomers comprising at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group. In another embodiment, the biodegradable branched polyester according to the present invention is characterised by branching obtained by a preparation process employing at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group. By a primary hydroxyl functional group is meant a functional group in which the carbon atom bonded to the hydroxyl group is bonded to only one carbon atom. By a secondary hydroxyl functional group is meant a functional group in which the carbon atom bonded to the hydroxyl group is bound to two carbon atoms. By a vicinal hydroxyl functional group is meant two hydroxyl groups bonded to two adjacent carbon atoms. Polyester branching according to the present invention is obtained using monomers comprising at least one polyfunctional compound containing at least four COOH and/or OH functional groups in concentrations of 0.1-0.45% mol, preferably 0.15-0.4% mol, more preferably 0.2-0.35% mol with respect to the total moles of the dicarboxylic component.

In a preferred embodiment biodegradable branched polyesters for extrusion coating according to the present invention is characterized by branching obtained by one polyfunctional compound containing at least four COOH and/or OH functional groups in concentrations of 0.1-0.45% mol with respect to the total moles of the dicarboxylic component, containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group, and said polyester being characterized by a viscoelastic ratio (RVE) of less than 40000.

In another preferred embodiment biodegradable branched polyesters for extrusion coating according to the present invention is characterized by branching obtained by the preparation process according to the present invention wherein the polyfunctional compound containing at least four COOH and/or OH functional groups in concentrations of 0.1-0.45% mol with respect to the total moles of the dicarboxylic component, containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group, and said polyester being characterized by a viscoelastic ratio (RVE) of less than 40000.

In another embodiment, the biodegradable branched polyester according to the present invention is characterised by branching obtained by a preparation process employing a mixture of polyfunctional compounds comprising at least 50% mol with respect to the total number of polyfunctional compounds of at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group.

Said polyfunctional compound is chosen from the group of polyfunctional molecules such as polyacids, polyols and their mixtures.

Examples of these polyacids are: pyromellitic acid, pyromellitic anhydride, ethylenediamine tetraacetic acid, furan-2,3,4,5-tetracarboxylic acid, naphthalene-1,4,5,8-tetracarboxylic acid, naphthalene-1,4,5,8-tetracarboxylic anhydride.

Examples of these polyols are: pentaerythritol, dipentaerythritol, ditrimethylolpropane, diglycerol, triglycerol, tetraglycerol and mixtures thereof.

Preferably the polyfunctional compound is pentaerythritol.

Surprisingly, the use of polyester according to the present invention in extrusion coating processes makes it possible to obtain improved properties in terms of thermal stability of the melt, Breaking Stretching Ratio and polydispersity index. Preferably, the thermal stability (K) of the polyester according to the present invention is less than 1.4×10⁻⁴ and preferably greater than −0.2×10⁻⁴, more preferably less than 1.2×10⁻⁴ and more preferably greater than 0, when determined at 180° C. and with flow gradient γ=103.7 s⁻¹ with a capillary having a diameter of 1 mm and L/D=30 according to ASTM standard D3835-90 “Standard test method for determining properties of polymer materials by means of a capillary rheometer”. Preferably the Breaking Stretching Ratio (BSR) of the polyester according to the present invention is less than 100, preferably less than 70 and preferably greater than 10 measured according to ISO 16790:2005 at 180° C. and γ=103.7 s⁻¹ using a capillary of diameter 1 mm and L/D=30 at a constant acceleration of 6 mm/sec² and a stretching length of 110 mm.

Preferably the polydispersity index (D) of the polyester according to the present invention is 2.4-3.5 measured using chloroform as eluent at 0.5 ml/min on columns suitable for the purpose (e.g. PL-gel columns (300×7.5 mm, 5 μm—mixed bed C and E) and a PLgel Guard pre-column (50×7.5 mm, 5 μm) connected in series) and a refractive index detector. The determination is made using a universal calibration made with a PS standard. The determination of the Mn and Mw indexes needed for the polydispersity index calculation is made by integrating the chromatogram by establishing a mass equal to 1500 as the lower limit. The polydispersity index (D) can be obtained as the ratio Mw/Mn, where Mw is the weight-average molar mass and Mn is the number-average molar mass.

A further object of the present invention is the use of polyester having improved rheological characteristics obtained according to the process according to the present invention for extrusion coating processes. The use of polyester according to the present invention in extrusion coating processes makes it possible to guarantee good processing conditions including in terms of thermal resistance of the melt, low neck-in (difference between the width of the laminar polymer layer at the extruder outlet and the width of the laminar polymer layer on the paper support), limited variation of the cross-sectional area of the melt film (so-called draw-resonance), as well as acceptable extruder motor consumption.

The polyester according to the present invention is characterised by a shear viscosity of less than 1000 Pa·s, preferably less than 970 Pa·s, and preferably greater than 250 Pa·s, determined at 180° C. and with a flow gradient γ=103.7 s⁻¹ with a capillary having a diameter of 1 mm and L/D=30 according to ASTM D3835-90 “Standard test method for determining the properties of polymer materials by means of a capillary rheometer”, and by a melt strength greater than 0.015 N, preferably greater than 0.02 N, and preferably less than 0.09 N, more preferably less than 0.05 N, measured according to ISO 16790:2005 at 180° C. and γ=103.7 s¹ using a capillary of diameter 1 mm and L/D=30 at a constant acceleration of 6 mm/sec² and a stretching length of 110 mm. The polyester according to the present invention is characterised by a viscosity to melt strength ratio, viscoelastic ratio (RVE), of less than 40000, preferably less than 30000, and preferably greater than 10000, more preferably greater than 110000, and even more preferably greater than 15000. Such values of RVE make the polyester according to the present invention particularly suitable for use in common extrusion coating or extrusion lamination equipment, and can be processed at lower temperatures than those used for corresponding polyesters characterised by higher RVE values and obtained by reactive post-extrusion, changing from processing temperatures of 280° C. to 240-250° C.

In a preferred embodiment, the biodegradable branched polyester for extrusion coating according to the present invention is characterised by a shear viscosity in the range of 1000 Pa·s. to 250 Pa·s, preferably in the range of 970 Pa·s. to 300 Pa·s, a melt strength in the range from 0.09 N to 0.015 N, preferably in the range from 0.05 N to 0.02 N, a viscoelastic ratio RVE in the range from 40000 to 10000, preferably in the range from 30000 to 15000.

The rheological characteristics of the polyester according to the present invention are such as to ensure good adhesion to substrates such as, for example, paper, cardboard, during the extrusion coating/lamination process. The rheological characteristics allow the polyester according to the present invention to be effectively fed to conventional extrusion coating equipment typically used for polyethylene without any particular changes in the structure and operating conditions of the machinery.

Among numerous advantages, the biodegradable branched polyester according to the present invention exhibits an improvement in colour compared to branched polyesters using polyfunctional compounds other than those described above. The effects on colour are advantageously determined according to the L*a*b* colour space using a Konica Minolta CR410 colorimeter. The measurement is made on a circular area with a diameter of 50 mm, standard observer at 2° and illuminant C. The polyester according to the present invention is characterised by a value of L* greater than 70, more preferably greater than 75, even more preferably greater than 80; by a value of a* less than 20, preferably less than 10, even more preferably less than 5 and a value of b* less than 30, preferably less than 20, even more preferably less than 15.

The biodegradable branched polyester according to the present invention is advantageously chosen from aliphatic and aliphatic-aromatic biodegradable polyesters. In a preferred embodiment, the polyester according to the present invention is an aliphatic-aromatic polyester.

As far as the aliphatic-aromatic polyesters are concerned, they have an aromatic part consisting mainly of polyfunctional aromatic acids, an aliphatic part consisting of aliphatic diacids and aliphatic diols and mixtures thereof. As far as the aliphatic-aromatic polyesters are concerned, the dicarboxylic component according to the present invention mainly comprises polyfunctional aromatic acids and aliphatic diacids, and the diol component mainly comprises aliphatic diols.

The aliphatic polyesters are obtained from aliphatic diacids and aliphatic diols and mixtures thereof. As far as the aliphatic polyesters are concerned, the dicarboxylic component according to the present invention mainly comprises aliphatic diacids, and the diol component mainly comprises aliphatic diols.

By polyfunctional aromatic acids are meant dicarboxylic aromatic compounds of the phthalic acid type, preferably terephthalic acid or isophthalic acid, more preferably terephthalic acid, and heterocyclic dicarboxylic aromatic compounds, preferably 2,5-furandicarboxylic acid, 2,4-furandicarboxylic acid, 2,3-furandicarboxylic acid, 3,4-furandicarboxylic acid, their esters, salts and mixtures.

The aliphatic diacids are aliphatic dicarboxylic acids with numbers of carbon atoms from C2 to C24, preferably C4-C13, more preferably C4-C11, their C1-C24, more preferably C1-C4, alkyl esters, their salts and mixtures thereof. Preferably, the aliphatic dicarboxylic acids are selected from: succinic acid, 2-methylsuccinic acid, 2-ethylsuccinic acid, glutaric acid, 2-methylglutaric acid, adipic acid, pimelic acid, suberic acid, azelaic acid, sebacic acid, undecandioic acid, dodecandioic acid, brassylic acid and their C1-C24 alkyl esters. Preferably said aliphatic dicarboxylic acids are selected from the group consisting of succinic acid, adipic acid, azelaic acid, sebacic acid, undecandioic acid, dodecandioic acid, brassylic acid and mixtures thereof.

The dicarboxylic component of the aliphatic or aliphatic-aromatic polyesters according to the present invention may comprise up to 5% unsaturated aliphatic dicarboxylic acids, preferably selected from itaconic acid, fumaric acid, 4-methylene-pimelic acid, 3,4-bis (methylene) nonandioic acid, 5-methylene-nonandioic acid, their C1-C24, preferably C1-C4, alkyl esters, their salts and mixtures thereof. In a preferred embodiment of the present invention, the unsaturated aliphatic dicarboxylic acids comprise mixtures comprising at least 50% in moles, preferably more than 60% in moles, more preferably more than 65% in moles of itaconic acid and/or its C1-C24, preferably C1-C4, esters. More preferably, the unsaturated aliphatic dicarboxylic acids consist of itaconic acid.

In the aliphatic or aliphatic-aromatic polyesters according to the present invention, diols are understood to mean compounds bearing two hydroxyl groups, preferably selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentyl glycol, 2-methyl-1,3-propanediol, dianhydrosorbitol, dianhydromannitol, dianhydroiditol, cyclohexanediol, 1,4-bis(hydroxymethyl)cyclohexane, dialkylene glycols and polyalkylene glycols with molecular weight 100-4000 such as polyethylene glycol, polypropylene glycol and mixtures thereof. Preferably, at least 50% in moles of the diol component comprises one or more diols chosen from 1,2-ethanediol, 1,3-propanediol, 1,4-butanediol. In a preferred embodiment of the present invention, the saturated aliphatic diol is 1,4-butanediol.

Advantageously, the diol can be obtained from a renewable source, from first or second generation sugars.

The diol component of the aliphatic or aliphatic-aromatic polyesters according to the present invention may comprise up to 5% of unsaturated aliphatic diols, preferably selected from cis 2-butene-1,4-diol, trans 2-butene-1,4-diol, 2-butyne-1,4-diol, cis 2-pentene-1,5-diol, trans 2-pentene-1,5-diol, 2-pentyne-1,5-diol, cis 2-hexene-1,6-diol, trans 2-hexene-1,6-diol, 2-hexyne-1,6-diol, cis 3-hexene-1,6-diol, trans 3-hexene-1,6-diol, 3-hexyne-1,6-diol.

The aliphatic or aliphatic-aromatic polyesters according to the present invention may further advantageously comprise repeating units derived from at least one hydroxy acid in an amount of 0-49% preferably 0-30% in moles relative to the total moles of the dicarboxylic component. Examples of convenient hydroxy acids are glycolic acid, glycolide, hydroxybutyric acid, hydroxycaproic acid, hydroxyvaleric acid, 7-hydroxyheptanoic acid, 8-hydroxyproic acid, 9-hydroxynonanoic acid, lactic acid or lactide. The hydroxy acids may be inserted into the chain as such or as prepolymers/oligomers, or they may also be reacted with diacid diols in advance.

The aliphatic-aromatic polyesters according to the present invention are characterised by an aromatic acid content of between 30 and 70% in moles, preferably between 40 and 60% in moles, with respect to the total dicarboxylic component.

In a preferred embodiment, the aliphatic-aromatic polyesters are preferably selected from the group consisting of: poly(1,4-butylene adipate-co-1,4-butylene terephthalate), poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate) poly(1,4-butylene adipate-co-1,4-butylene azelate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene succinate-co-1,4-butylene terephthalate), poly(1,4-butylene azelate-co-1,4-butylene succinate-co-1,4-butylene adipate-co-1,4-butylene terephthalate), poly(1,4-butylene azelate-co-1,4-butylene succinate-co-1,4-butylene sebacate-co-1,4-butylene terephthalate), poly(1,4-butylene azelate-co-1,4-butylene succinate-co-1,4-butylene brassylate-co-1,4-butylene terephthalate), poly(1,4-butylene azelate-co-1,4-butylene succinate-co-1,4-butylene adipate-co-1,4-butylene sebacate-co-1,4-butylene terephthalate), poly(1,4-butylene azelate-co-1,4-butylene succinate-co-1,4-butylene adipate-co-1,4-butylene brassylate-co-1,4-butylene terephthalate), poly(1,4-butylene azelate-co-1,4-butylene succinate-co-1,4-butylene brassylate-co-1,4-butylene sebacate-co-1,4-butylene terephthalate), poly(1,4-butylene azelate-co-1,4-butylene succinate-co-1,4-butylene adipate-co-1,4-butylene sebacate-co-1,4-butylene brassylate-co-1,4-butylene terephthalate). In a particularly preferred embodiment the aliphatic-aromatic polyester is poly(1,4-butylene adipate-co-1,4-butylene terephthalate).

Mixtures of the various polyesters of the invention also form part of the invention.

The biodegradable branched polyester according to the present invention is substantially gel-free.

The biodegradable branched polyesters according to the invention are biodegradable according to EN13432.

The polyester according to the present invention may further optionally comprise 0-5% by weight, more preferably 0.05-4% by weight, even more preferably 0.05-3% by weight of the total mixture, of at least one crosslinking agent and/or chain extender.

Said crosslinking agent and/or chain extender improves stability to hydrolysis and is selected from di- and/or polyfunctional compounds bearing isocyanate, peroxide, carbodiimide, isocyanurate, oxazoline, epoxide, anhydride, divinyl ether groups and mixtures thereof.

Preferably, the crosslinking agent and/or chain extender comprises at least one di- and/or polyfunctional compound bearing epoxide or carbodiimide groups.

Preferably, the crosslinking agent and/or chain extender comprises at least one di- and/or polyfunctional compound bearing isocyanate groups. More preferably, the crosslinking agent and/or chain extender comprises at least 25% by weight of one or more di- and/or polyfunctional compounds bearing isocyanate groups. Particularly preferred are mixtures of di- and/or polyfunctional compounds bearing isocyanate groups with di- and/or polyfunctional compounds bearing epoxide groups, even more preferably comprising at least 75% by weight of di- and/or polyfunctional compounds bearing isocyanate groups.

The di- and polyfunctional compounds bearing isocyanate groups are preferably selected from p-phenylene diisocyanate, 2,4-toluene diisocyanate, 2,6-toluene diisocyanate, 4,4-diphenylmethane-diisocyanate, 1,3-phenylene-4-chlorodiisocyanate, 1,5-naphthalene diisocyanate, 4,4-diphenylene diisocyanate, 3,3′-dimethyl-4,4-diphenylmethane diisocyanate, 3-methyl-4,4′-diphenylmethane diisocyanate, diphenylester diisocyanate, 2,4-cyclohexane diisocyanate, 2,3-cyclohexane diisocyanate, 1-methyl 2,4-cyclohexyl diisocyanate, 1-methyl-2,6-cyclohexyl diisocyanate, bis(isocyanate cyclohexyl) methane, 2,4,6-toluene triisocyanate, 2,4,4-diphenylether triisocyanate, polymethylene-polyphenyl-polyisocyanates, methylene diphenyl diisocyanate, triphenylmethane triisocyanate, 3,3′-ditolylene-4,4-diisocyanate, 4,4′-methylenebis(2-methyl-phenyl isocyanate), hexamethylene diisocyanate, 1,3-cyclohexylene diisocyanate, 1,2-cyclohexylene diisocyanate and mixtures thereof. In a preferred embodiment, the compound bearing isocyanate groups is 4,4-diphenylmethane-diisocyanate.

As for the di- and polyfunctional compounds bearing peroxide groups, these are preferably selected from benzoyl peroxide, lauroyl peroxide, isononanoyl peroxide, di(t-butylperoxyisopropyl)benzene, t-butyl peroxide, dicumyl peroxide, alpha,alpha′-di(t-butylperoxy)diisopropylbenzene, 2,5-dimethyl-2,5-di(t-butylperoxy)hexane, t-butyl cumyl peroxide, di-t-butyl peroxide, 2,5-dimethyl-2,5-di(t-butylperoxy)hex-3-yne, di(4-t-butylcyclohexyl)peroxy dicarbonate dicetyl peroxycarbonate, dimyristyl peroxycarbonate, 3,6,9-triethyl-3,6,9-trimethyl-1,4,7-triperoxonane, di(2-ethylhexyl) peroxycarbonate and mixtures thereof. The di- and polyfunctional compounds bearing carbodiimide groups which are preferably used in the mixture according to the present invention are chosen from poly(cyclooctylene carbodiimide), poly(1,4-dimethylcy clohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide), poly(neopentylene carbodiimide), poly(1,4-dimethylene phenylene carbodiimide), poly(2,2′,6,6′-tetraisopropyldiphenylene carbodiimide) (Stabaxol® D), poly(2,4,6-triisolpropyl-1,3-phenylene carbodiimide) (Stabaxol® P-100), poly(2,6-diisopropyl-1,3-phenylene carbodiimide) (Stabaxol® P), poly(tolyl carbodiimide), poly(4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethylcarbodiimide), 1,6-hexamethylene bis(ethylcarbodiimide), 1,8-octamethylene bis(ethylcarbodiimide), 1,10-decamethylene bis(ethylcarbodiimide), 1,12-dodecamethylene bis(ethylcarbodiimide) and mixtures thereof.

Examples of di- and polyfunctional compounds bearing epoxide groups which may advantageously be used in the mixture according to the present invention are all polyepoxides from epoxidised oils and/or styrene-glycidyl ether-methyl methacrylate, glycidyl ether-methyl methacrylate, within a molecular weight range of 1000 to 10000 and with a number of epoxides per molecule in the range from 1 to 30 and preferably 5 to 25, and epoxides selected from the group comprising: diethylene glycol diglycidyl ether, polyethylene glycol diglycidyl ether, polyglycerol polyglycidyl ether, 1,2-epoxybutane, polyglycerol polyglycidyl ether, isoprene diepoxide, and cycloaliphatic diepoxides, 1,4-cyclohexanedimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, tetraglycidyl ether of meta-xylene diamine and diglycidyl ether of bisphenol A and mixtures thereof.

In a particularly preferred embodiment of the invention, the crosslinking agent and/or chain extender comprises compounds bearing isocyanate groups, preferably 4,4-diphenylmethane diisocyanate, and/or bearing carbodiimide groups, and/or bearing epoxide groups, preferably of the styrene-glycidyl ether-methylmethacrylate type. In a particularly preferred embodiment of the invention, the crosslinking agent and/or chain extender comprises compounds bearing epoxide groups of the styreneglycidyl ether-methylmethacrylate type.

Along with di- and polyfunctional compounds bearing isocyanate, peroxide, carbodiimide, isocyanurate, oxazoline, epoxide, anhydride, divinyl ether groups, catalysts may also be used to increase the reactivity of the reactive groups. In the case of polyepoxides, fatty acid salts are preferably used, even more preferably calcium and zinc stearates.

The biodegradable branched polyester according to the invention can be mixed with other polymers of synthetic or natural origin, whether biodegradable or not. Compositions comprising polyester according to the present invention are also an object of the present invention.

As regards the biodegradable and non-biodegradable polymers of synthetic or natural origin, these are advantageously selected from the group consisting of polyhydroxyalkanoates, vinyl polymers, polyesters from diol diacid, polyamides, polyurethanes, polyethers, polyureas, polycarbonates and mixtures thereof. In a particularly preferred form, said polymers may be mixed with the biodegradable polyester according to the invention in amounts of up to 80% by weight.

As for the polyhydroxyalkanoates, these may be present in amounts between 30 and 80% w/w, preferably between 40 and 75% w/w, even more preferably between 45 and 70% w/w, relative to the total composition.

Said polyhydroxyalkanoates are preferably selected from the group consisting of the polyesters of lactic acid, poly-ε-caprolactone, polyhydroxybutyrate, polyhydroxybutyrate-valerate, polyhydroxybutyrate-propanoate, polyhydroxybutyrate-hexanoate, polyhydroxybutyrate-decanoate, polyhydroxybutyrate-dodecanoate, polyhydroxybutyrate-hexadecanoate, polyhydroxybutyrate-octadecanoate, poly 3-hydroxybutyrate-4-hydroxybutyrate. Preferably, the polyhydroxyalkanoate of the composition comprises at least 80% w/w of one or more polyesters of lactic acid.

In a preferred embodiment, the lactic acid polyesters are selected from the group consisting of poly L-lactic acid, poly D-lactic acid, poly D-L lactic acid complex stereo, copolymers comprising more than 50% in moles of said lactic acid polyesters or mixtures thereof.

Particularly preferred are lactic acid polyesters containing at least 95% by weight of repeating units derived from L-lactic or D-lactic acid or combinations thereof, of molecular weight Mw greater than 50000 and with a shear viscosity between 50 and 700 Pa·s preferably between 80 and 500 Pa·s (measured according to ASTM D3835 standard at T=190° C., shear rate=1000 s⁻¹, D=1 mm, L/D=10).

In a particularly preferred embodiment of the present invention, the lactic acid polyester comprises at least 95% w/w of units derived from L-lactic acid, ≤5% w/w of repetitive units derived from D-lactic acid, exhibits a Melting Temperature in the range 135-175° C., a Glass Transition Temperature (Tg) in the range 55-65° C. and an MFR (measured according to ASTM-D1238 standard at 190° C. and 2.16 kg) in the range 1-50 g/10 min.

Commercial examples of lactic acid polyesters with these properties include Ingeo™ Biopolymer brand products 4043D, 3251D, 6202D, Luminy® brand product L105.

In a preferred embodiment of the present invention, the composition comprises a biodegradable branched polyester according to the present invention and at least one polyhydroxyalkanoate. In an even more preferred embodiment of the present invention, the composition comprises (i) 20 to 50% by weight, preferably 25 to 45% by weight, of the biodegradable branched polyester according to the present invention, (ii) 50 to 80% by weight, preferably 55 to 75% by weight, of a lactic acid polyester, based on the sum of the weight of components (i) and (ii).

Preferred vinyl polymers include polyethylene, polypropylene, their copolymers, polyvinyl alcohol, polyvinyl acetate, polyethylene vinyl acetate and polyethylene vinyl alcohol, polystyrene, chlorinated vinyl polymers, polyacrylates.

Chlorinated vinyl polymers include, in addition to polyvinyl chloride, polyvinylidene chloride, polyethylene chloride, poly(vinyl chloride-vinyl acetate), poly(vinyl chloride-ethylene), poly(vinyl chloride-propylene), poly(vinyl chloride-styrene), poly(vinyl chloride-isobutylene) as well as copolymers in which polyvinyl chloride accounts for more than 50% in moles. Said copolymers may be random, block or alternating.

With regard to the polyamides of the composition according to the present invention, these are preferably selected from the group consisting of polyamide 6 and 6,6, polyamide 9 and 9,9, polyamide 10 and 10,10, polyamide 11 and 11,11, polyamide 12 and 12,12 and combinations thereof of the 6/9, 6/10, 6/11, 6/12 types, their blends and both random and block copolymers.

Preferably, the polycarbonates of the composition according to the present invention are selected from the group consisting of polyalkylene carbonates, more preferably polyethylene carbonates, polypropylene carbonates, polybutylene carbonates, mixtures thereof and both random and block copolymers.

Among the polyethers, those preferred are selected from the group consisting of polyethylene glycols, polypropylene glycols, polybutylene glycols their copolymers and their mixtures with molecular weights from 5000 to 100000.

As for the diacid diol polyesters, these preferably include:
(a) a dicarboxylic component comprising, in relation to the total dicarboxylic component
(a1) 20-100% in moles of units derived from at least one aromatic dicarboxylic acid,
(a2) 0-80% in moles of units derived from at least one saturated aliphatic dicarboxylic acid,
(a3) 0-5% in moles of units derived from at least one unsaturated aliphatic dicarboxylic acid;
(b) a diol component comprising, in relation to the total diol component:
(b1) 95-100% in moles of units derived from at least one saturated aliphatic diol;
(b2) 0-5% in moles of units derived from at least one unsaturated aliphatic diol.

Preferably, aromatic dicarboxylic acids a1, saturated aliphatic dicarboxylic acids a2, unsaturated aliphatic dicarboxylic acids a3, saturated aliphatic diols b1 and unsaturated aliphatic diols b2 for said polyesters are selected from those described above for polyester according to the present invention.

As for polymers of natural origin, these are advantageously selected from starch, chitin, chitosan, alginates, proteins such as gluten, zein, casein, collagen, gelatine, natural gums, cellulose (also in nanofibrils) and pectin.

The term starch is understood here to mean all types of starch, namely: flour, native starch, hydrolysed starch, destructured starch, gelatinised starch, plasticised starch, thermoplastic starch, biofillers comprising complexed starch or mixtures thereof. Particularly suitable according to the invention are starches such as potato, maize, tapioca and pea starch. Particularly advantageous are starches which can be easily deconstructed and which have high initial molecular weights, such as potato or maize starch. Starch may be present both as such and in a chemically modified form, e.g., as starch esters with a degree of substitution between 0.2 and 2.5, as hydroxypropylated starch, as modified starch with fat chains.

By destructured starch, reference is made herein to the teachings contained in Patents EP-0 118240 and EP-0 327 505, starch being understood as being processed in such a way that it does not substantially exhibit so-called “Maltese crosses” under the optical microscope in polarised light and so-called “ghosts” under the optical microscope in phase contrast.

Advantageously, the destructuring of the starch is carried out by an extrusion process at temperatures between 110-250° C., preferably 130-180° C., pressures between 0.1-7 MPa, preferably 0.3-6 MPa, preferably providing a specific energy greater than 0.1 kWh/kg during said extrusion.

Destructuring of the starch preferably takes place in the presence of 1-40% by weight, with respect to the weight of the starch, of one or more plasticisers chosen from water and polyols having from 2 to 22 carbon atoms. The water may also be the water naturally present in the starch. Among the polyols, preference is given to polyols having 1 to 20 hydroxyl groups containing 2 to 6 carbon atoms, their ethers, thioethers and organic and inorganic esters.

Examples of such polyols are glycerol, diglycerol, polyglycerol, pentaerythritol, ethoxylated polyglycerol, ethylene glycol, polyethylene glycol, 1,2-propanediol, 1,3-propanediol, 1,4-butanediol, neopentylglycol, sorbitol, sorbitol monoacetate, sorbitol diacetate, sorbitol monoethoxylate, sorbitol diethoxylate, and mixtures thereof.

In a preferred embodiment, the starch is destructured in the presence of glycerol or a mixture of plasticisers comprising glycerol, more preferably comprising between 2% and 90% by weight of glycerol. Preferably, the destructured and cross-linked starch according to the present invention comprises between 1-40% w/w of plasticisers relative to the weight of the starch.

When present, the starch in the composition according to the present invention is preferably in the form of particles having a circular, elliptical or otherwise ellipse-like cross-section having an arithmetic mean diameter of less than 1 μm, measured taking into account the major axis of the particle, and more preferably less than 0.5 μm mean diameter.

The biodegradable branched polyester according to the invention may also optionally be blended with one or more additives selected from the group consisting of plasticisers, UV stabilisers, lubricants, nucleating agents, surfactants, antistatic agents, pigments, compatibilising agents, lignin, silymarin organic acids, antioxidants, anti-mould agents, waxes, process aids and polymer components preferably selected from the group consisting of vinyl polymers and diol diacid polyesters other than or the same as the aliphatic and/or aliphatic-aromatic polyesters described above.

Each additive is present in quantities preferably less than 10% by weight, more preferably less than 5% by weight, and even more preferably less than 1% by weight of the total weight of the mixture.

With respect to the plasticisers, in addition to the plasticisers preferably used for the preparation of destructured starch described above, these are selected from the group consisting of trimellitates, such as trimellitic acid esters with C4-C20 mono-alcohols preferably selected from the group consisting of n-octanol and n-decanol, and aliphatic esters having the following structure:

R1-O—C(O)-R4-C(O)—[—O-R2-O—C(O)-R5-C(O)-]m-O-R3

in which:
R1 is selected from one or more of the groups formed by H, linear and branched saturated and unsaturated type C1-C24 alkyl residues, polyol residues esterified with C1-C24 monocarboxylic acids;
R2 comprises -CH2-C(CH3)2-CH2- and alkylene C2-C8-groups, and consists of at least 50% in moles of said -CH2-C(CH3)2-CH2- groups;
R3 is selected from one or more of the groups formed by H, linear and branched, saturated and unsaturated alkyl residues of the C1-C24 type, polyol residues esterified with C1-C24 monocarboxylic acids;
R4 and R5 are the same or different, comprise one or more C2-C22, preferably C2-C11, more preferably C4-C9, alkenes, and comprise at least 50% in moles of C7 alkenes;
m is an integer between 1-20, preferably 2-10, more preferably 3-7.

Preferably, in said esters at least one of groups R1 and/or R3 comprises, preferably in an amount ≥10% in moles, more preferably ≥20%, even more preferably ≥25% in moles, with respect to the total amount of groups R1 and/or R3, polyol residues esterified with at least one C1-C24 monocarboxylic acid selected from the group consisting of stearic acid, palmitic acid, 9-ketostearic acid, 10-ketostearic acid and mixtures thereof. Examples of such aliphatic esters are described in Italian patent application MI2014A000030 and international patent applications WO 2015/104375 and WO 2015/104377.

The lubricants are preferably chosen from esters and metal salts of fatty acids such as, for example, zinc stearate, calcium stearate, aluminium stearate and acetyl stearate. Preferably, the composition according to the present invention comprises up to 1% by weight of lubricants, more preferably up to 0.5% by weight, relative to the total weight of the composition.

Examples of nucleating agents include saccharin sodium salt, calcium silicate, sodium benzoate, calcium titanate, boron nitride, isotactic polypropylene, low molecular weight PLA. Pigments may also be added, if necessary, e.g., titanium dioxide, clays, copper phthalocyanine, titanium dioxide, silicates, iron oxides and hydroxides, carbon black, and magnesium oxide. With regard to process aids such as slipping and/or releasing agents, these include, for example, biodegradable fatty acid amides such as oleamide, erucamide, ethylene-bis-stearylamide, fatty acid esters such as glycerol oleates or glycerol stearates, saponified fatty acids such as stearates, inorganic agents such as silicas or talc. The process aids are preferably present in an amount of less than 10% by weight, more preferably less than 5% by weight, even more preferably less or equal than 1% by weight of the total weight of the mixture.

It is an object of the present invention to use polyester according to the present invention in an extrusion coating or extrusion lamination process.

It is an object of the present invention to provide laminated articles obtained by extrusion coating or extrusion lamination, comprising at least one substrate and at least one first layer comprising polyester according to the invention. Said articles include boxes, glasses, plates, lids, food packaging.

It is an object of the present invention to provide fibres, films or sheets comprising polyester according to the present invention, consisting of one or more layers. Advantageously, the polyester according to the present invention can be used as a tie layer between the different layers.

The invention will now be illustrated with a few examples of embodiments which are intended to illustrate but not limit the scope of protection of the present patent application.

### EXAMPLES

### Branched Polyesters:

(i) Poly(1,4-butylene adipate-co-1,4-butylene terephthalate): The synthesis process was carried out in a 316L stainless steel reactor with a geometric volume of 25 litres equipped with: a mechanical stirring system, a distillation line consisting of a packed-fill column and a shell-and-tube cooler equipped with a condensate collection drum, a polymerisation line equipped with a high-boil abatement system, cold traps and a mechanical vacuum pump, and an inlet for nitrogen. The reactor was charged with: terephthalic acid 2653 g (15.98 mol), adipic acid 2631 g (18.02 mol), 1,4-butanediol 4284 g (47.6 mol), branching agent as per Table 1, 1.78 g of diisopropyl triethanolamine titanate (Tyzor TE, amounting to 250 ppm by weight and 21 ppm metal to final polymer). The temperature was raised to 235° C. over 90 min and held at 235° C. until an esterification conversion of more than 95% was achieved, as calculated from the mass of reaction water distilled from the system. At the end of the esterification step a first gradual vacuum ramp was instituted up to a pressure of 100 mbar in 20 minutes to complete esterification, the pressure was then restored with nitrogen and the polycondensation catalyst was added: a mixture of tetrabutyl titanate (TnBT) and tetrabutyl zirconate (NBZ) consisting of 2.97 g TnBT (amounting to 417 ppm catalyst and 58 ppm metal) and 7.08 g NBZ (equal to 994 ppm catalyst and 206 ppm metal). The pressure in the reactor was reduced to below 3 mbar over 30 minutes and the temperature was raised to 245° C. and maintained until the desired molecular mass, estimated from the consumption of the stirring motor, was reached. At the end of the reaction the vacuum was neutralised with nitrogen and the material was extruded through a die in the form of filaments. The filaments were cooled in a water bath, dried with a stream of air and granulated with a cutter.
(ii) Poly(1,4-butylene adipate-co-butylene azelate-co-1,4-butylene terephthalate): The synthesis process was carried out in a 316L stainless steel reactor with a geometric volume of 25 litres and equipped with: a mechanical stirring system, a distillation line consisting of a packed-fill column and a shell and tube cooler equipped with a condensate collection drum, a polymerisation line equipped with a high-boil abatement system, cold traps and a mechanical vacuum pump, and an inlet for nitrogen. The reactor was charged with: terephthalic acid 2653 g (15.98 mol), adipic acid 2236 g (15.32 mol), azelaic acid 508 g (2.70 mol) 1,4-butanediol 4284 g (47.6 mol), branching agent as per Table 1, 1.81 g of diisopropyl triethanolamine titanate (Tyzor TE, equal to 250 ppm by weight and 21 ppm metal to final polymer). The temperature was raised to 235° C. over 90 minutes and held at 235° C. until an esterification conversion of more than 95% was achieved, as calculated from the mass of reaction water distilled from the system. At the end of the esterification step a first gradual vacuum ramp was instituted up to a pressure of 100 mbar in 20 minutes to complete esterification, the pressure was then restored with nitrogen and the polycondensation catalyst was added: a mixture of tetrabutyl titanate (TnBT) and tetrabutyl zirconate (NBZ) consisting of 3.02 g TnBT (amounting to 417 ppm catalyst and 58 ppm metal) and 7.19 g NBZ (amounting to 994 ppm catalyst and 206 ppm metal). The pressure in the reactor was reduced to below 3 mbar over 30 minutes and the temperature was raised to 245° C. and maintained until the desired molecular mass, estimated from the consumption of the stirring motor, was reached. At the end of the reaction the vacuum was neutralised with nitrogen and the material was extruded through a die in the form of filaments. The filaments were cooled in a water bath, dried with a stream of air and granulated with a cutter.
(iii) Poly(1,4-butylene succinate): The synthesis process was carried out in a 316L stainless steel reactor with a geometric volume of 25 litres and equipped with: a mechanical stirring system, a distillation line consisting of a packed fill column and a shell and tube cooler equipped with a condensate collection drum, a polymerisation line equipped with a high-boil abatement system, cold traps and a mechanical vacuum pump, and a nitrogen inlet. The reactor was charged with: succinic acid 4956 g (42.00 mol), 1,4-butanediol 4536 g (50.4 mol), branching agent as per Table 1, 0.9 g of diisopropyl triethanolamine titanate (Tyzor TE, amounting to 125 ppm by weight and 10.5 ppm metal to final polymer). The temperature was raised to 235° C. over 90 minutes and held at 235° C. until an esterification conversion of more than 95% was achieved, as calculated from the mass of reaction water distilled from the system. At the end of the esterification step a first gradual vacuum ramp was instituted up to a pressure of 100 mbar in 20 minutes to complete esterification, the pressure was then restored with nitrogen and the polycondensation catalyst was added: a mixture of tetrabutyl titanate (TnBT) and tetrabutyl zirconate (NBZ) consisting of 2.9 g of TnBT (equivalent to 401 ppm of catalyst and 56 ppm of metal) and 8.5 g of NBZ (equivalent to 1177 ppm of catalyst and 244 ppm of metal). The pressure in the reactor was reduced to below 3 mbar over 30 minutes and the temperature was raised to 245° C. and maintained until the desired molecular mass, estimated from the consumption of the stirring motor, was reached. At the end of the reaction the vacuum was neutralised with nitrogen and the material was extruded through a die in the form of filaments. The filaments were cooled in a water bath, dried with a stream of air and granulated with a cutter.

Composition (iv):

Composition consisting of 37% by weight of polyester i), 62.8% by weight of Ingeo 3251D polylactic acid, 0.2% by weight of Joncryl ADR4368-CS. Composition iv) was fed to a co-rotating twin-screw extruder model Icma San Giorgio MCM 25 HT operating under the following conditions:

Screw diameter(D)=25 mm

L/D=52

Screw turns=150 rpm

Thermal profile=50−110−200×5−190×5−160−180° C.
Flow rate 10 kg/hour
Vacuum degassing.

TABLE 1

| | | Branching agent in the polyester | | | Shear | Melt | | | | |
|---|---|---|---|---|---|---|---|---|---|---|
| | Polyester or | | quantity | quantity | viscosity | strength | | K | | |
| Example | composition | type | [mol %]. | [g] | [Pa · s] | [N] | RVE | ×10⁴ | BSR | D |
| 1 | i | penta- | 0.3 | 13.87 | 721 | 0.044 | 16386 | 1.18 | 33 | 2.85 |
| | | erythritol | | | | | | | | |
| 2 | ii | penta- | 0.3 | 13.87 | 583 | 0.023 | 25347 | 0.95 | 40 | 2.72 |
| | | erythritol | | | | | | | | |
| 3 | i | diglycerol | 0.3 | 16.63 | 933 | 0.041 | 22756 | 1.12 | 22 | 2.94 |
| 4 | iv | penta- | 0.3 | 13.87 | 683 | 0.024 | 28458 | 0.1 | 57 | 3.38 |
| | including the | erythritol | | | | | | | | |
| | polyester from | | | | | | | | | |
| | example 1 | | | | | | | | | |
| 5 | i | pyromellitic | 0.2 | 17.27 | 965 | 0.034 | 28382 | 0.42 | 38 | 3.03 |
| | | acid | | | | | | | | |
| 6 | iii | penta- | 0.3 | 17.14 | 357 | 0.031 | 11516 | 0.60 | 32 | 3.27 |
| | | erythritol | | | | | | | | |
| 1 | i | glycerine | 0.3 | 9.38 | 720 | 0.006 | 120000 | 0.68 | 142 | 2.07 |
| comparative | | | | | | | | | | |
| 2 | iv | glycerine | 0.3 | 9.38 | 838 | 0.011 | 76181 | 0.20 | 88 | 2.31 |
| comparative | including the | | | | | | | | | |
| | polyester from | | | | | | | | | |
| | comparative | | | | | | | | | |
| | example 1 | | | | | | | | | |
| 3 | i | Trimethylol- | 0.3 | 13.67 | 782 | 0.0104 | 75192 | 2.38 | 100 | 2.12 |
| comparative | | propane | | | | | | | | |
| 4 | i | erythritol | 0.3 | 12.44 | 1124 | 0.010 | 112400 | 0.99 | 140 | 1.99 |
| comparative | | | | | | | | | | |
| 5 | i | citric acid | 0.3 | 19.58 | 553 | 0.008 | 69125 | 2.74 | 71 | 2.25 |
| comparative | | | | | | | | | | |

The data shown in Table 1 show that optimum RVE values are obtained only in the presence of a biodegradable branched polyester characterised by branching obtained by a preparation process employing at least one polyfunctional compound containing at least four acid (COOH) or at least four hydroxyl (OH) functional groups, wherein at least two of said hydroxyl functional groups are primary and at least further two of said hydroxyl functional groups are primary or secondary, providing that, if present, the secondary hydroxyl group is not vicinal to another secondary hydroxyl group.

1) A process for obtaining a biodegradable branched polyester for extrusion coating comprising (i) an esterification/transesterification step in the presence of a diol and dicarboxylic components, and at least one polyfunctional compound containing at least four acid (COOH) or at least four hydroxyl (OH) functional groups, wherein at least two of said hydroxyl functional groups are primary and at least further two of said hydroxyl functional groups are primary or secondary, provided that, if present, the secondary hydroxyl group is not vicinal to another secondary hydroxyl group, and an esterification/transesterification catalyst; and (ii) a polycondensation step in the presence of a polycondensation catalyst.

2) The process for obtaining a biodegradable branched polyester according to claim 1, wherein said catalyst used in the (i) esterification/transesterification and (ii) polycondensation steps is a Titanium compound.

3) A biodegradable branched polyester for extrusion coating, characterised by branching obtained by the preparation process of claim 1, wherein the polyfunctional compound containing at least four acid (COOH) or at least four hydroxyl (OH) functional groups is present in a concentration of 0.1-0.45% mol with respect to the total moles of the dicarboxylic component, wherein at least two of said hydroxyl functional groups are primary and at least further two of said hydroxyl functional groups are primary or secondary, providing that, if present, the secondary hydroxyl group is not vicinal to another secondary hydroxyl group, said polyester being further characterised by a viscoelastic ratio (RVE) of less than 40000.

4) The biodegradable branched polyester according to claim 3, characterised by a viscoelastic ratio (RVE) of less than 30000.

5) The biodegradable branched polyester according to claim 3, wherein the polyfunctional compound is selected from polyols, polyacids and mixtures thereof.

6) The biodegradable branched polyester according to claim 5, wherein said polyol is selected from the group consisting of pentaerythritol, dipentaerythritol, ditrimethylolpropane, diglycerol, triglycerol, tetraglycerol, and mixtures thereof.

7) The biodegradable branched polyester according to claim 6, wherein said polyol is pentaerythritol.

8) The biodegradable branched polyester according to claim 3, wherein said polyester is selected from aliphatic and aliphatic-aromatic biodegradable polyesters.

9) The biodegradable branched polyester according to claim 8, wherein said polyester is an aliphatic-aromatic polyester.

10) The biodegradable branched polyester according to claim 9, wherein said aliphatic-aromatic polyester is characterised by an aromatic acid content of between 30 and 70% in moles, relative to the total dicarboxylic component.

11) The biodegradable branched polyester according to claim 9, wherein said aliphatic-aromatic polyester is selected from the group consisting of poly(1,4-butylene adipate-co-1,4-butylene terephthalate), poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butylene adipate-co-1,4-butylene azelate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene sucinate-co-1,4-butylene terephthalate), poly(1,4-butylene azelate-co-1,4-butylene succinate-co-1,4-butylene adipate-co-1,4-butylene terephthalate), poly(1,4-butylene azelate-co-1,4-butylene succinate-co-1,4-butylene sebacate-co-1,4-butylene terephthalate), poly(1,4-butylene azelate-co-1,4-butylene succinate-co-1,4-butylene brassylate-co-1,4-butylene terephthalate), poly(1,4-butylene azelate-co-1,4-butylene succinate-co-1,4-butylene adipate-co-1,4-butylene sebacate-co-1,4-butylene terephthalate), poly(1,4-butylene azelate-co-1,4-butylene succinate-co-1,4-butylene adipate-co-1,4-butylene brassylate-co-1,4-butylene terephthalate), poly(1,4-butylene azelate-co-1,4-butylene succinate-co-1,4-butylene brassylate-co-1,4-butylene sebacate-co-1,4-butylene terephthalate), poly(1,4-butylene azelate-co-1,4-butylene succinate-co-1,4-butylene adipate-co-1,4-butylene sebacate-co-1,4-butylene brassylate-co-1,4-butylene terephthalate).

12) The biodegradable branched polyester for extrusion coating, characterised by a shear viscosity from 1000 Pa·s to 250 Pa·s, a melt strength from 0.09 N to 0.015 N, and a viscoelastic ratio RVE from 40000 to 10000.

13) A polymer composition comprising the biodegradable branched polyester according to claim 3 and at least one polyhydroxyalkanoate.

14) A polymer composition comprising: i) 20 to 50% by weight of biodegradable branched polyester according to claim 3, ii) 50 to 80% by weight of a lactic acid polyester, based on the sum of the weight of components (i) and (ii).

15) A film comprising biodegradable branched polyester according to claim 3.

16) A laminated article obtained by extrusion coating or extrusion lamination, comprising at least one substrate and at least one first layer consisting of the biodegradable branched polyester according to claim 3.

17) A method for producing a laminated article which comprises extrusion coating or extrusion laminating a biodegradable branched polyester according to claim 3 on at least one substrate.

18) A biodegradable branched polyester for extrusion coating, characterised by branching obtained by the preparation process of claim 2, wherein the polyfunctional compound containing at least four acid (COOH) or at least four hydroxyl (OH) functional groups is present in a concentration of 0.1-0.45% mol with respect to the total moles of the dicarboxylic component, wherein at least two of said hydroxyl functional groups are primary and at least further two of said hydroxyl functional groups are primary or secondary, providing that, if present, the secondary hydroxyl group is not vicinal to another secondary hydroxyl group, said polyester being further characterised by a viscoelastic ratio (RVE) of less than 40000.

19) The biodegradable branched polyester according to claim 18, wherein the polyfunctional compound is selected from polyols, polyacids and mixtures thereof.

20) The biodegradable branched polyester according to claim 10, wherein said aliphatic-aromatic polyester is selected from the group consisting of poly(1,4-butylene adipate-co-1,4-butylene terephthalate), poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butylene adipate-co-1,4-butylene azelate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene sucinate-co-1,4-butylene terephthalate), poly(1,4-butylene azelate-co-1,4-butylene succinate-co-1,4-butylene adipate-co-1,4-butylene terephthalate), poly(1,4-butylene azelate-co-1,4-butylene succinate-co-1,4-butylene sebacate-co-1,4-butylene terephthalate), poly(1,4-butylene azelate-co-1,4-butylene succinate-co-1,4-butylene brassylate-co-1,4-butylene terephthalate), poly(1,4-butylene azelate-co-1,4-butylene succinate-co-1,4-butylene adipate-co-1,4-butylene sebacate-co-1,4-butylene terephthalate), poly(1,4-butylene azelate-co-1,4-butylene succinate-co-1,4-butylene adipate-co-1,4-butylene brassylate-co-1,4-butylene terephthalate), poly(1,4-butylene azelate-co-1,4-butylene succinate-co-1,4-butylene brassylate-co-1,4-butylene sebacate-co-1,4-butylene terephthalate), poly(1,4-butylene azelate-co-1,4-butylene succinate-co-1,4-butylene adipate-co-1,4-butylene sebacate-co-1,4-butylene brassylate-co-1,4-butylene terephthalate).
